(19) United States
(12) Patent Application Publication
(10) Pub. No.: US 2025/0329961 A1
(43) Pub. Date: Oct. 23, 2025

(54) LOW PROFILE PARK LOCK ACTUATOR PCB RETENTION

(71) Applicant: Stoneridge Control Devices, Inc., Novi, MI (US)

(72) Inventors: Yulanda King, Amherst, NY (US); Lisa Robins, Milford, MI (US); Patrick Mullaly, Brighton, MI (US)

(21) Appl. No.: 18/637,632

(22) Filed: Apr. 17, 2024

(51) Int. Cl. H01R 13/629; H01R 12/72; H01R 13/514; H01R 43/20

(52) U.S. Cl. CPC H01R 13/629; H01R 12/721; H01R 13/514; H01R 43/205; H01R 2201/26

(57) ABSTRACT

An actuator for a vehicle driveline component includes a housing that has first and second housing portions. The housing provides an electrical connector. A motor is configured to move an output shaft between first and second positions, the motor and the output shaft are arranged in the housing. A gear train is arranged in the housing, the gear train couples the motor to the output shaft. A printed circuit board (PCB) is electrically connected to the electrical connector and the motor. The PCB is retained in a desired location by a clamping force that is exerted on the PCB by the first and second housing portions.

### TECHNICAL FIELD

This disclosure relates to an actuator for use in a vehicle driveline, for example, a park lock actuator for use in locking a transmission and/or differential to prevent the vehicle from moving when parked.

### BACKGROUND

Park lock actuators are typically two-position devices used to lock and unlock a vehicle driveline component. During vehicle operation, the park lock actuator is unlocked, permitting the driveline to impart rotational drive from a power source to the vehicle's wheels. When the vehicle is parked and not operating, the park lock actuator either manually or automatically engages to lock the driveline component and prevent movement of the vehicle. One type of park lock actuator is driven by an electric motor in response to a switch and/or controller. Park lock actuators must meet customer packaging constraints.

### SUMMARY

In one exemplary embodiment, an actuator for a vehicle driveline component includes a housing that includes first and second housing portions. The housing provides an electrical connector. A motor is configured to move an output shaft between first and second positions, the motor and the output shaft are arranged in the housing. A gear train is arranged in the housing, the gear train couples the motor to the output shaft. A printed circuit board (PCB) is electrically connected to the electrical connector and the motor. The PCB is retained in a desired location by a clamping force that is exerted on the PCB by the first and second housing portions.

In a further embodiment of any of the above, the PCB includes apertures, and the first housing portion includes locating features that extend into and cooperate with the apertures to provide the desired location. The first housing portion is engaged to one side of the PCB, and the second housing portion is engaged to another side of the PCB opposite the one side.

In a further embodiment of any of the above, the PCB is retained in the desired location against movement in X-, Y- and Z-directions with melted weld material from the locating features in a melted state. The clamping force is maintained in the melted state.

In a further embodiment of any of the above, a perimeter of one of the first and second housing portions is secured to the other of the first and second housing portions by a retention element. The retention element maintains the clamping force.

In a further embodiment of any of the above, the retention element is a weld bead.

In a further embodiment of any of the above, the PCB is retained in the desired location against movement in X- and Y-directions with melted weld material from the locating features that expands outward to the PCB filling any gaps.

In a further embodiment of any of the above, conductive pins extend from the first housing portion. The conductive pins are in electrical communication with the electrical connector, and the conductive pins extend through the PCB and are electrically connected thereto.

In a further embodiment of any of the above, the apertures include at least one notch that is located at a perimeter of the PCB, and the locating features includes at least one boss.

In a further embodiment of any of the above, the apertures include at least one hole, and the locating features include at least one standoff that has a first width portion and a second width portion. The second width portion is smaller than the first width portion in an unmelted state to form a shoulder that engages the one side of the PCB. The second width portion is disposed in the at least one hole.

In a further embodiment of any of the above, the PCB has a thickness that extends a first height, and the second width portion has a second height that is greater than the first height in an unmelted state. The second width portion is in engagement with the second housing portion in the unmelted state and the melted state. The second width portion is wider in the melted state to fill the at least one hole more than in the unmelted state.

In a further embodiment of any of the above, the second housing portion includes a protrusion that extends to engage the PCB on the one side, and the second housing portion includes a cavity that adjoins the protrusion. The cavity is arranged over an electronic component on the PCB that extends into the cavity.

In a further embodiment of any of the above, the actuator includes a plate that is secured to the first housing portion. The plate locates the gear train, and the PCB is spaced apart from and in non-engagement with the plate. The output shaft includes a first position sensing element, and the PCB has a second position sensing element. The desired location corresponds to a desired alignment between the first and second position sensing elements.

In another exemplary embodiment, a method of manufacturing an actuator for a vehicle driveline component includes a) mounting a motor to a first housing portion, b) installing a gear train into the first housing portion, the gear train is couples the motor to an output shaft, c) locating a printed circuit board (PCB) at a desired location on the first housing portion, and d) securing a second housing portion to the first housing portion to enclose the motor, the gear train and the PCB. The securing step creates a clamping force on the PCB that retains the PCB in the desired location relative to the first and second housing portions.

In a further embodiment of any of the above, the method includes a step of securing a plate to the first housing portion to support the gear train prior to performing step c). The output shaft includes a first position sensing element, and the PCB has a second position sensing element. The desired location corresponds to a desired alignment between the first and second position sensing elements.

In a further embodiment of any of the above, step c) includes inserting conductive pins that extend from the first housing portion into the PCB to electrically connect the second positioning element to an electrical connector that is provided on the first housing portion.

In a further embodiment of any of the above, step c) includes arranging apertures on the PCB relative to locating features on the first housing portion to provide the desired location such that one side of the PCB engages the first housing portion, and step d) includes laser welding the locating features to a melted state to secure the locating features to the second housing portion to maintain the clamping force.

### BRIEF DESCRIPTION OF THE DRAWINGS

The disclosure can be further understood by reference to the following detailed description when considered in connection with the accompanying drawings wherein:

FIG. 1 is a schematic view of a vehicle drive train including the disclosed actuator.

FIGS. 2A and 2B are respectively a perspective side view and cross-sectional view of an example low profile park lock actuator (PLA) with a disclosed printed circuit board (PCB) retention.

FIG. 3 is an exploded view of the PLA and its housing shown in FIGS. 2A and 2B.

FIG. 4A is a perspective view of an output shaft sub-assembly including a sector gear and a first position sensing element.

FIG. 4B is a perspective view of a plate sub-assembly.

FIG. 4C is a perspective view of a PCB.

FIG. 4D is a perspective view of a first housing portion sub-assembly.

FIGS. 5A and 5B illustrate an example PLA manufacturing process.

FIG. 6 is an enlarged perspective view of one example PCB aperture cooperating with a locating feature on the PLA housing to provide a desired location for the PCB and feature to which the cover is laser welded.

FIG. 7 is an enlarged cross-sectional view depicting first and second housing portions clamping and retaining the PCB in the desired location.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible. Like reference numbers and designations in the various drawings indicate like elements.

### DETAILED DESCRIPTION

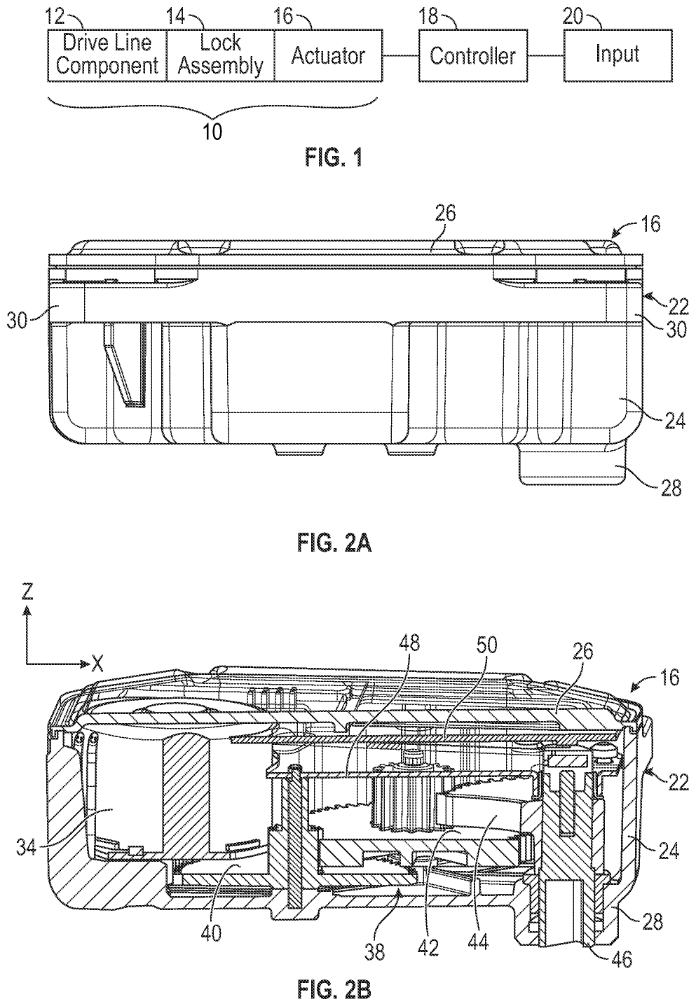

FIG. 1 illustrates a drive train 10 having a driveline component 12 such as a transmission or differential. The driveline component imparts drive from the vehicle's propulsion system to the wheels. One type of drive train 10 includes a lock assembly 14 that moves between locked and unlocked positions to permit rotation of the driveline component during vehicle operation and lock out any rotation when the vehicle is parked to prevent the vehicle from rolling. The lock assembly 14 is operated by an actuator 16 that receives an electrical signal from a controller 18 and/or an input 20 such as a switch. Although the disclosed actuator is described as being for use in a 2-position park-lock system, it should be understood that the actuator may have other applications and operate in more than two positions for those applications.

Referring to FIGS. 2A and 2B, the actuator 16 includes a plastic housing 22 having first and second housing portions 24, 26. The housing 22 (e.g., first housing portion 24) provides an electrical connector 30 for communication with the controller 18 and/or input 20. An electric motor 34 is arranged in the housing 22 and rotationally drives an output shaft 46 between first and second positions (e.g., locked and unlocked). A gear train 38 is arranged in the housing 22 and couples the motor 34 to the output shaft 46, which is located relative to the drive line component 12 by a locating portion 28 of the housing 22 that may be received by a correspondingly shaped aperture. Mounting ears 32 are provided by the housing 22 to secure the actuator 16 to the drive line component 12 or other supporting structure.

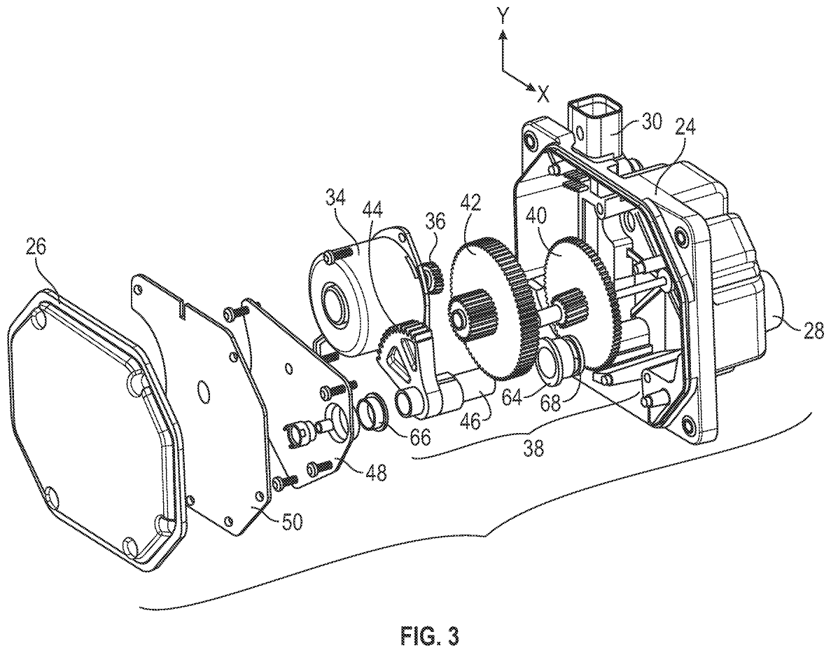

As shown in FIGS. 2A and 3, the gear train 38 has a first compound gear 40 coupled to a pinion 36 driven by the motor 34. A second compound gear 42 mates with the first compound gear 40 and a sector gear 44 mounted to the output shaft 46. The disclosed gear train 38 provides a flat, compact arrangement suitable for limited packaging space, although other types of gear trains may be used.

A plate 48 is arranged over the gear train 38 and secured to the first housing portion 24 to locate the gear train 38. In the example, the output shaft 46 is received and located by first and second bushings 64, 66 respectively mounted in the first housing portion 24 and the plate 48. A seal 68 is provided in the first housing portion 24 and around the output shaft 46 to prevent water and debris from entering the enclosed housing 22.

A printed circuit board (PCB) 50 is spaced apart from and in non-engagement with the plate 48 in the disclosed example. The output shaft 46 includes a first position sensing element 70a, and the PCB 50 has a second position sensing element 70b that is aligned with the first position sensing element 70a when the actuator 16 is fully assembled. The first and second position sensing elements 70a, 70b together comprise a position sensor that monitors the rotational position of the output shaft 46 (e.g., locked or unlocked positions), which provides operational feedback to the PCB 50 and/or controller 18.

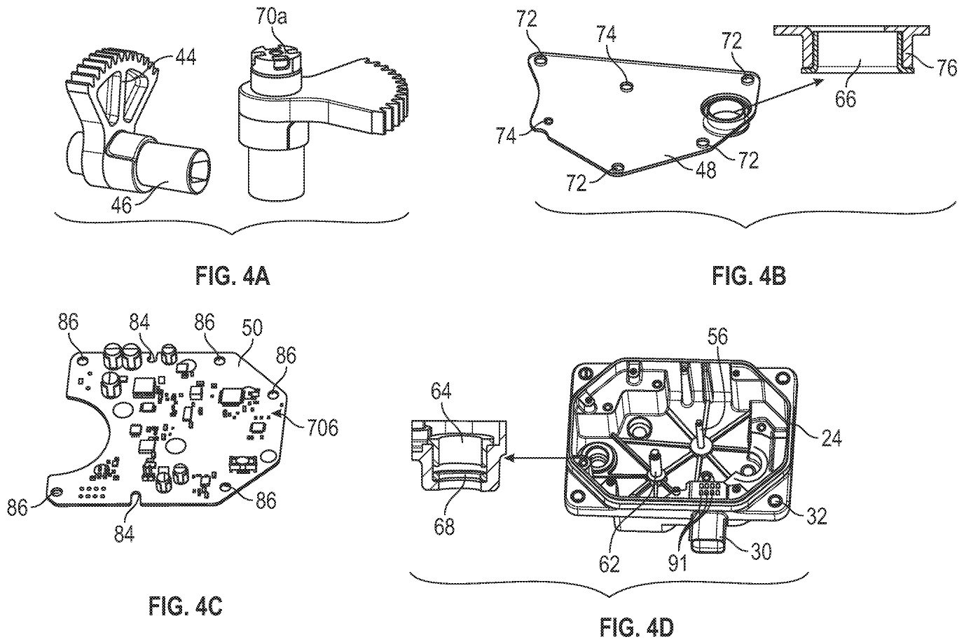

FIGS. 4A-4D illustrate several example sub-assemblies used in manufacturing the disclosed actuator 16. Referring to FIG. 4A, an output shaft sub-assembly is shown having the sector gear 44 over-molded onto the output shaft 46. The first position sensing element 70a is mounted to one end of the output shaft 46.

FIG. 4B is a perspective view of a plate sub-assembly in which the plate 48 is provided with mounting holes 72 used to secure the plate 48 to the housing 22. Shaft holes 74 are used to support the first and second compound gears 40, 42. An extruded hole 76 is provided in the plate 48 and receives the second bushing 66 that supports the output shaft 46.

FIG. 4C is a perspective view of a first housing portion sub-assembly in which first housing portion 24 supports first and second shafts 56, 62 that respectively rotationally support the first and second compound gears 40, 42. The first bushing 64 and seal 68 are installed into the first housing portion 24 for receiving the output shaft 46. The first housing portion 24 is provided with pins 91 that are in electrical communication with the connector 30.

FIG. 4D is a perspective view of the PCB 50 and its various electronic components supported by its substrate. The PCB 50 includes apertures for locating the PCB 50 relative to the first housing portion 24 in a desired location when installed. In one example, the apertures are provided by at least one notch 84 extending to the PCB's perimeter, and at least one hole 86.

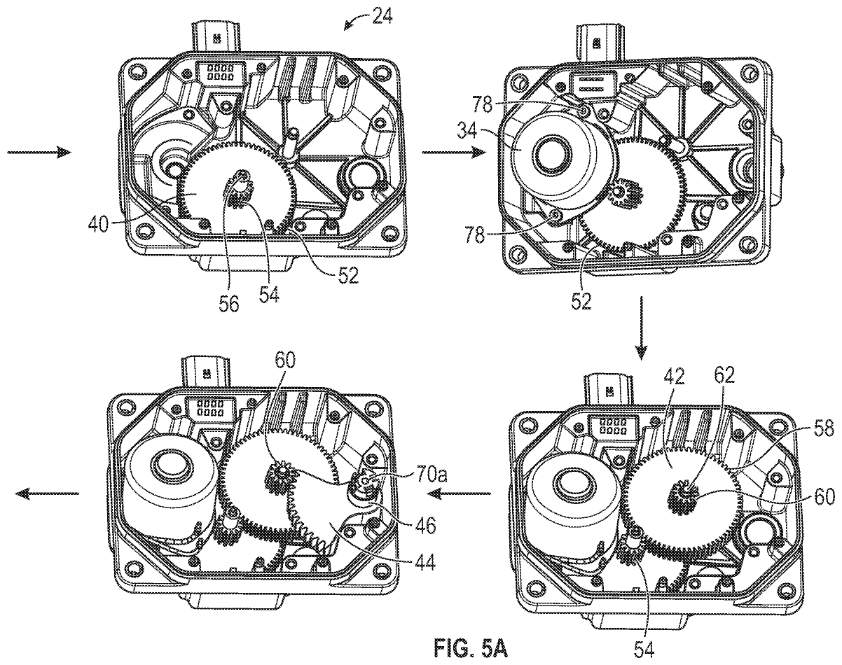

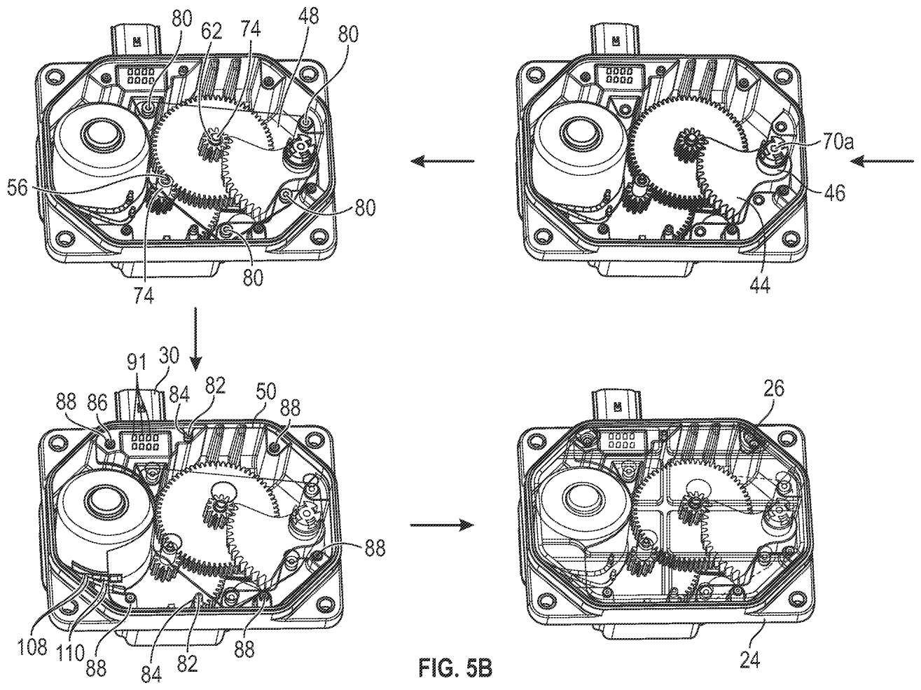

FIGS. 5A and 5B illustrate an example actuator 16 manufacturing process. As shown in FIG. 5A, the first compound gear 40 is installed into the first housing portion sub-assembly by the mounting first compound gear 40 onto the first shaft 56. Next, the motor 34 is secured to the first housing portion 24 with motor fasteners 78, mating the pinion 36 to the first gear 52. The second compound gear 42 is installed onto the second shaft 62, mating the third gear 58 with the second gear 54. The output shaft sub-assembly is installed next, inserting the output shaft 46 through the first bushing 64 and seal 64. The sector gear 44 is mated with the fourth gear 60.

Referring to FIG. 5B, the plate sub-assembly is installed over the gear train 38 such that the shaft holes 74 receive and support the first and second shafts 56, 62. The output shaft 46 is received in the second bushing 66 for support. Plate fasteners 80 extend through the mounting holes 72 to secure the plate 48 to the first housing portion 24.

The PCB 50 includes apertures (e.g., notches 84 and/or holes 86), and the first housing portion 24 includes locating features (e.g., bosses 82 and/or standoffs 88) extending into and cooperating with respective apertures in the PCB 50 to provide a desired location. The desired location corresponds to, for example, alignment between the first and second position sensing elements 70a, 70b. When the PCB 50 is set into the first housing 24 at the desired location, the conductive pins 91 will extend through the PCB 50 such that they are electrically connected thereto, for example, by solder or terminals. The PCB 50 is also electrically connected to the motor 34. For example, wires 110 from the motor 34 are positioned in channels 108 in the first housing portion 24, and the wires 110 are soldered or connected by terminals to the PCB 50.

With the PCB 50 in its desired location, the first housing portion 24 engages one side of the PCB 50. The second housing portion 26 is arranged over the first housing portion 24 to enclose and seal the actuator's internal components. The second housing portion 26 engages the other side of the PCB 50 to retain the PCB 50 in its desired location by a clamping force exerted on the PCB 50 by the first and second housing portions 24, 26. The PCB 50 is retained in the desired location against movement in X-, Y- and Z-directions without fasteners, directly and firmly securing the PCB 50 with the housing 22. A perimeter 96 of one of the first and second housing portions 24, 26 is secured to the other of the first and second housing portions 24, 26 by a retention element, such as a weld bead 98, to maintain the clamping force on the PCB 50 post-assembly. The first and second housing portions 24, 26 can be melted together using a laser beam at the same time the PCB's locating features are melted, which is discussed below. This reduces assembly time and cost by eliminating fasteners, such as screws.

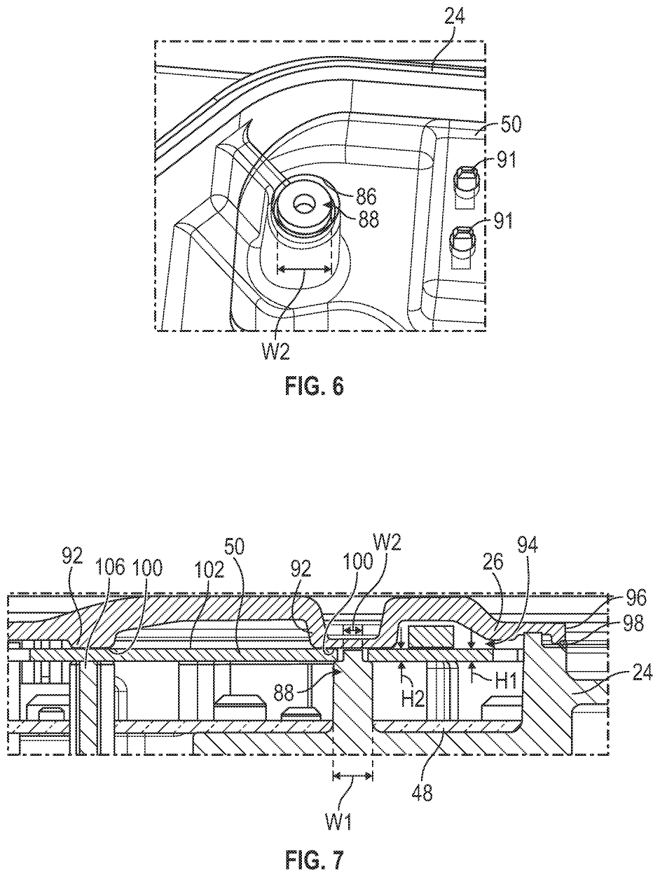

The arrangement of apertures and locating features are further described in connection with FIGS. 6 and 7. The standoff 88 has a first width portion W1 and a second width portion W2 that is smaller than the first width portion W1 in an unmelted state, which forms a shoulder 90. The shoulder 90 engages and supports the one side of the PCB, and the second width portion W2 is disposed in a corresponding hole 86 in the PCB 50. The PCB 50 has a thickness extending a first height H1, and the second width portion W2 has a second height H2 that is greater than the first height H1 in an unmelted state. As a result, the second width portion W2 will be in engagement with the second housing portion 26 in the unmelted state. so that the second housing portion 26 can apply the clamping force to the PCB 50. The bosses 86, if any, will be similarly recessed and spaced from the second housing portion 26.

The second housing portion 26 includes one or more protrusions 92 extending to a first surface 100 that engages a second surface 102 of the PCB 50, for example. One or more walls 106 may support the underside of the PCB 50 opposite the second housing portion 26. The second housing portion 26 may also include a cavity adjoining the protrusion 92 to accommodate an electronic component on the PCB 50. The second housing portion 26 may also be relatively flat, if desired.

The second housing portion 26, which acts as a cover, is a laser beam transparent plastic. Regardless, the first surface 100, or underside of the second housing portion 26, is used to engage the PCB 50. When securing the first and second housing portions 24, 26 to one another, a laser beam is directed through the second housing portion 26 at each of the standoffs 88 to melt the second width portion W2. Once in the melted state, the second width portion W2 flows and expands into its respective aperture 86 to fill the gap between the PCB 50 and the locating feature, which eliminates any X-, Y-movement of the PCB. X-, Y-, Z-movement of the PCB may also be eliminated to maintain the clamping force by also melting to and retaining engagement with the second housing portion 26. This enables the actuator 16 to have a relatively compact envelope.

It should also be understood that although a particular component arrangement is disclosed in the illustrated embodiment, other arrangements will benefit herefrom. Although particular step sequences are shown, described, and claimed, it should be understood that steps may be performed in any order, separated or combined unless otherwise indicated and will still benefit from the present invention.

Although the different examples have specific components shown in the illustrations, embodiments of this invention are not limited to those particular combinations. It is possible to use some of the components or features from one of the examples in combination with features or components from another one of the examples.

Although an example embodiment has been disclosed, a worker of ordinary skill in this art would recognize that certain modifications would come within the scope of the claims. For that reason, the following claims should be studied to determine their true scope and content.

What is claimed is:

1. An actuator for a vehicle driveline component, comprising:
a housing including first and second housing portions, the housing providing an electrical connector;
a motor configured to move an output shaft between first and second positions, the motor and the output shaft arranged in the housing;
a gear train arranged in the housing, the gear train coupling the motor to the output shaft; and
a printed circuit board (PCB) electrically connected to the electrical connector and the motor, the PCB retained in a desired location by a clamping force exerted on the PCB by the first and second housing portions.

2. The actuator of claim 1, wherein the PCB includes apertures, and the first housing portion includes locating features extending into and cooperating with the apertures to provide the desired location, the first housing portion engaging one side of the PCB, and the second housing portion engaging another side of the PCB opposite the one side.

3. The actuator of claim 2, wherein the PCB is retained in the desired location against movement in X-, Y- and Z-directions with melted weld material from the locating features in a melted state, wherein the clamping force is maintained in the melted state.

4. The actuator of claim 3, wherein a perimeter of one of the first and second housing portions is secured to the other of the first and second housing portions by a retention element, the retention element maintaining the clamping force.

5. The actuator of claim 4, wherein the retention element is a weld bead.

6. The actuator of claim 2, wherein the PCB is retained in the desired location against movement in X- and Y-directions with melted weld material from the locating features that expands outward to the PCB filling any gaps.

7. The actuator of claim 2, wherein conductive pins extend from the first housing portion, the conductive pins are in electrical communication with the electrical connector, and the conductive pins extend through the PCB and are electrically connected thereto.

8. The actuator of claim 2, wherein the apertures include at least one notch located at a perimeter of the PCB, and the locating features includes at least one boss.

9. The actuator of claim 2, wherein the apertures includes at least one hole, and the locating features incudes at least one standoff having a first width portion and a second width portion, the second width portion is smaller than the first width portion in an unmelted state to form a shoulder that engages the one side of the PCB, wherein the second width portion is disposed in the at least one hole.

10. The actuator of claim 9, wherein the PCB has a thickness extending a first height, and the second width portion has a second height greater than the first height in an unmelted state, the second width portion in engagement with the second housing portion in the unmelted state and the melted state, the second width portion wider in the melted state to fill the at least one hole more than in the unmelted state.

11. The actuator of claim 2, wherein the second housing portion includes a protrusion extending to engage the PCB on the one side, and the second housing portion includes a cavity adjoining the protrusion, the cavity arranged over an electronic component on the PCB that extends into the cavity.

12. The actuator of claim 1, comprising a plate secured to the first housing portion, the plate locating the gear train, and the PCB spaced apart from and in non-engagement with the plate, the output shaft includes a first position sensing element, and the PCB has a second position sensing element, the desired location corresponding to a desired alignment between the first and second position sensing elements.

13. A method of manufacturing an actuator for a vehicle driveline component, comprising:
a) mounting a motor to a first housing portion;
b) installing a gear train into the first housing portion, the gear train coupling the motor to an output shaft;
c) locating a printed circuit board (PCB) at a desired location on the first housing portion; and
d) securing a second housing portion to the first housing portion to enclose the motor, the gear train and the PCB, wherein the securing step creates a clamping force on the PCB that retains the PCB in the desired location relative to the first and second housing portions.

14. The method of claim 13, comprising a step of securing a plate to the first housing portion to support the gear train prior to performing step c), wherein the output shaft includes a first position sensing element, and the PCB has a second position sensing element, the desired location corresponding to a desired alignment between the first and second position sensing elements.

15. The method of claim 14, wherein step c) includes inserting conductive pins extending from the first housing portion into the PCB to electrically connect the second positioning element to an electrical connector provided on the first housing portion.

16. The method of claim 14, wherein step c) includes arranging apertures on the PCB relative to locating features on the first housing portion to provide the desired location such that one side of the PCB engages the first housing portion, and step d) includes laser welding the locating features to a melted state to secure the locating features to the second housing portion to maintain the clamping force.
